(19) United States
(12) Patent Application Publication
(10) Pub. No.: US 2026/0236472 A1
(43) Pub. Date: Aug. 13, 2026

(54) SYSTEM AND METHOD FOR FINDING RELEVANT TABLES IN A DATABASE BACKUP TO ANSWER AN UNSTRUCTURED QUERY

(71) Applicant: Eon IO, Ltd., Tel Aviv (IL)

(72) Inventors: Benjamin GRUENBAUM, Herzliya (IL); Ron KIMCHI, Tel Aviv (IL); Amir YONATAN, Tel Aviv-Yafo (IL); Assaf NATANZON, Tel Aviv (IL); Erez REUVEN, Raanana (IL)

(73) Assignee: Eon IO, Ltd., Tel Aviv (IL)

(21) Appl. No.: 19/051,917

(22) Filed: Feb. 12, 2025

(51) Int. Cl. G06F 16/2455; G06F 16/174; G06F 16/22

(52) U.S. Cl. CPC G06F 16/2455; G06F 16/174; G06F 16/2237

(57) ABSTRACT

A method and system for identifying relevant database tables in a database backup are provided. The method includes receiving an input query, wherein the input query is a free text query; generating a prompt for a first language model that, when executed by a generative AI system, provides a set of column names most relevant to answering the input query; embedding a search vector for the set of relevant column names; and identifying relevant database tables by performing a similarity search between the search vector and vectors in a vector database, wherein the vectors in a vector database represent at least a portion of contents of database tables in the database backup.

### TECHNICAL FIELD

The present disclosure relates generally to digital backup and restoration, and specifically to looking up for database tables to query.

### BACKGROUND

Database backup is the process of creating copies of data to protect against data loss, corruption, or hardware failure. Backups ensure that information can be restored if something goes wrong, maintaining data availability and minimizing downtime.

A relational database (SQL database) stores and provides access to data that is organized into tables, which consist of rows and columns. Each table represents a specific entity (like customers, orders, or products), and each row in a table represents a unique record of that entity. Columns represent the attributes of the entity, such as a customer's name or an order's date. Such databases are often stored across multiple tables to avoid redundancy and ensure consistency. A non-relational database (often called NoSQL database) is a type of database that does not use the traditional table-based relational structure (rows and columns) like SQL databases. Instead, it uses flexible data models that allow for scalability, speed, and diverse data storage. Examples of NoSQL databases include MongoDB and CouchDB. Examples of SQL databases include PostgreSQL, MySQL, MSSQL, and the like.

Querying a vast number of databases, especially when the databases include a mix of both relational and non-relational databases, presents a number of challenges. Additionally, the number of tables to search to answer a query can be vast and is complicated when tables are distributed across different databases. When querying numerous databases containing thousands of tables, identifying the relevant tables to query can be extremely time-consuming and resource-intensive. Additionally, the organization and labeling of tables and columns within the databases are often not standardized. This lack of uniformity can make it challenging to identify which tables and columns are relevant for a particular query. For example, different tables might use different names for similar data, such as “last name” in one table and “family name” in another, leading to inefficiencies and increased costs in terms of both time and computational resources when retrieving information to answer the query.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation cause(s) the system to perform the actions. One or more computer programs can be configured to perform particular operations or actions by virtue of including instructions that, when executed by a data processing apparatus, cause the apparatus to perform the actions.

In one general aspect, the method may include receiving an input query, where the input query is a free text query. The method may also include generating a prompt for a first language model that, when executed by a generative AI system, provides a set of column names most relevant to answering the input query. The method may furthermore include embedding a search vector for the set of relevant column names. The method may in addition include identifying relevant database tables by performing a similarity search between the search vector and vectors in a vector database, where the vectors in a vector database represent at least a portion of contents of database tables in the database backup. Other embodiments of this aspect include corresponding computer systems, apparatus, and computer programs recorded on one or more computer storage devices, each configured to perform the actions of the methods.

Implementations may include one or more of the following features. The method where generating a prompt for a first language model further may include: presenting, to a user, options for a deterministic value based on the input query, where a deterministic value is a value that is specific and unambiguous; and modifying the input query based on a user selection of an option for a deterministic value, where the modified input query includes at least the deterministic value and the received input query. The method where the database backup includes the vector database. The method may include generating the vector database, where generating the vector database further may include: reading column names and at least a portion of contents associated with each column name of database tables in a database backup; and standardizing the column names in an exported table. The method may include embedding each column name into a respective vector, where each respective vector includes embeddings of the column name and at least a portion of contents associated with each column name; and storing the vector embeddings in the vector database. The method may include: generating a prompt for a second language model based on at least contents of the column, where the prompt, when executed by the generative AI system, outputs a standardized column name of the column, where the first language model is different than the second language model. The identified relevant database tables are stored in the database backup, where the database tables are different database applications. A database application is at least any one of: a NoSQL database application and a SQL database application. The first language model is tuned based on column names in the database backup. Implementations of the described techniques may include hardware, a method or process, or a computer tangible medium.

In one general aspect, a non-transitory computer-readable medium may include one or more instructions that, when executed by one or more processors of a device, cause the device to: receive an input query, where the input query is a free text query; generate a prompt for a first language model that, when executed by a generative AI system, provides a set of column names most relevant to answering the input query; embed a search vector for the set of relevant column names; and identify relevant database tables by performing a similarity search between the search vector and vectors in a vector database, where the vectors in a vector database represent at least a portion of contents of database tables in the database backup. Other embodiments of this aspect include corresponding computer systems, apparatus, and computer programs recorded on one or more computer storage devices, each configured to perform the actions of the methods.

In one general aspect, the system may include one or more processors configured to receiving an input query, where the input query is a free text query; generating a prompt for a first language model that, when executed by a generative AI system, provides a set of column names most relevant to answering the input query; embedding a search vector for the set of relevant column names; identifying relevant database tables by performing a similarity search between the search vector and vectors in a vector database, where the vectors in a vector database represent at least a portion of contents of database tables in the database backup. Other embodiments of this aspect include corresponding computer systems, apparatus, and computer programs recorded on one or more computer storage devices, each configured to perform the actions of the methods.

Implementations may include one or more of the following features. The system where the one or more processors, when generating a prompt for a first language model, are configured to: present, to a user, options for a deterministic value based on the input query, where a deterministic value is a value that is specific and unambiguous; and modify the input query based on a user selection of an option for a deterministic value, where the modified input query includes at least the deterministic value and the received input query. The system where the database backup includes the vector database. The system where the one or more processors are further configured to: generate the vector database, where generating the vector database further may include: reading column names and at least a portion of contents associated with each column name of database tables in a database backup; and standardize the column names in an exported table. The system where the one or more processors are further configured to: embed each column name into a respective vector, where each respective vector includes embeddings of the column name and at least a portion of contents associated with each column name; and store the vector embeddings in the vector database. The system where the one or more processors are further configured to: embed each column name into a respective vector, where each respective vector includes embeddings of the column name and at least a portion of contents associated with the column name; and store the vector embeddings in the vector database. The system where the one or more processors are further configured to: generate a prompt for a second language model based on at least contents of the column, where the prompt, when executed by the generative AI system, outputs a standardized column name of the column. The system where the first language model is different than the second language model. The system where the identified relevant database tables are database tables stored in the database backup, the database tables being different database applications. The system where a database application is at least any one of: a NoSQL database application and a SQL database application. The system where the first language model is tuned based on column names in the database backup.

Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram that includes a backup system utilized to describe an embodiment.

FIG. 2 is an example flowchart of a method for generating a database backup (DB) that can be utilized for finding relevant tables in accordance with an embodiment.

FIG. 3 is an example flowchart of a process for vectorizing a set of column names of tables stored in a DB backup and storing each vector in a vector database according to an embodiment.

FIG. 4 is an example process for identifying tables with the most relevant columns in response to an input query according to an embodiment.

FIG. 5 is an example schematic diagram of a backup system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments allow for identifying relevant tables in databases of the same type, different types (e.g., MySQL and MongoDB), or within the same database in response to a user's input query. Querying for relevant tables in databases, according to the disclosed embodiments, includes performing a similarity search between embedded vectors representing column names identified by an LLM as relevant to answering the query and vectors, stored in a vector database, representing the column names of tables across multiple databases.

It should be noted that, in some embodiments, reference to embedding vectors representing column names includes the fact that embedding such vectors encompasses embedding the contents of the cells that belong to the column. According to this embodiment, each column name and the column contents (or portion thereof) associated with the column name are part of the embedded vector. In some embodiments, each vector includes the embedding of the column name and the embeddings of all associated column contents. In some embodiments, each vector includes the embedding of the column name and the embeddings of a subset of all associated column contents.

The disclosed embodiments streamline the process of identifying relevant tables and columns, thereby increasing computer efficiency. By standardizing the column names of tables in the databases as well as the column names recommended by the LLM, the vectors that are embedded for the column names can be accurately and efficiently compared. By allowing such accurate and efficient similarity searches in the vector database, the disclosed embodiments may identify tables with column names that are relevant to an input query. The standardization and vectorization improve the way the data (column names) is indexed and retrieved (in a vector database). This improvement allows for quick identification of the tables that include the most relevant column names across many databases using only a single query. This would save time by reducing the need for users to manually sift through numerous tables to find the data they need. Additionally, the disclosed embodiments minimize the processing power and memory required to execute queries, leading to faster response times and lower operational costs.

The disclosed embodiments further allow for organization scale and for integration of database solutions using fewer computer resources and in less time. It should be emphasized that currently there is no solution in the related art that allows for querying multiple tables residing in different databases of different types (e.g., MySQL and MongoDB) through a single interface.

Note that NoSQL databases use different terminology than SQL (relational) databases for the data they store. For example, in SQL databases, the following terms correspond to terms in a NoSQL database: “table” corresponds to a “collection,” a “row” is similar to a “document,” a “column” is equivalent to a “field,” and a “primary key” is represented by an “ID,” which serves as the default unique identifier. This description will primarily employ terminology from SQL databases for clarity, but the disclosed embodiments are not limited to these types of databases.

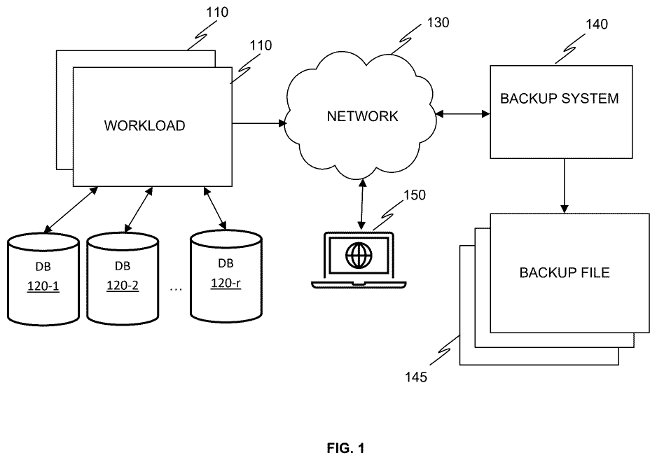

FIG. 1 is an example network diagram including a database backup system, utilized to describe some disclosed embodiments. As illustrated in FIG. 1, a plurality of databases 120-1, 120-2, . . . , 120-r is backed up by the backup system 140 into backup files 145. Database 120 may include a database application, a database management system (DBMS), a combination thereof, and the like. In some embodiment, a database 120 may be a column-oriented database, a relational database, a tabular relational database, a document-oriented database, and the like. For example, a database 120-1 is implemented using MySQL and a database 120-1 is MongoDB. In an embodiment, database 120 may include metadata, such as a database schema. In some embodiments, the database schema includes a data structure, such as a table, including a plurality of keys, at least a portion of which correspond to columns of the table.

In certain embodiments, the databases 120 are deployed on one or more workloads 110. In an embodiment, workload 110 is a physical computing device, a virtual computing device (e.g., a virtual machine), a combination thereof, and the like. In some embodiments, a workload 110 is a software container. In an embodiment, a software container is deployed on a software container platform, such as Kubernetes®, Docker®, and the like.

According to an embodiment, a workload 110 is implemented as a virtual machine, a software container, a serverless function, a combination thereof, and the like. In some embodiments, a database 120 is implemented as a managed database, for example utilizing Amazon® RDS. In an embodiment, a virtual machine is deployed as an Amazon® EC2 instance. A software container is deployed on a container platform such as Kubernetes®, Docker®, and the like. In some embodiments, a serverless function is deployed as an Amazon® Lambda function.

In an embodiment, workload 110 is configured to provide access to database 120, for example, over a network 130. In some embodiments, a cloud computing infrastructure is implemented on network 130. For example, in an embodiment, a cloud computing infrastructure is Amazon® Web Services (AWS), Google® Cloud Platform (GCP), Microsoft® Azure, and the like. In certain embodiments, the cloud computing infrastructure is utilized to deploy a cloud computing environment. In an embodiment, a cloud computing environment is a virtual private cloud (VPC), a virtual network (VNet), a virtual private network (VPN), a combination thereof, and the like.

In some embodiments, workload 110 is configured to provide access to database 120 to a database backup system 140 (also referred to as a backup system 140). In an embodiment, backup system 140 is configured to generate a backup of databases 120. In an embodiment, backup system 140 is implemented as a virtual machine, a software container, a serverless function, a combination thereof, and the like.

In an embodiment, backup system 140 is configured to generate a backup of a database by determining a retrieval key of database 120. For example, the database (DB) backup includes only data of the database. Data of the database includes data exported from the database, a database schema, a combination thereof, and the like.

According to an embodiment, data, information, and the like that allow the generation of a restored machine include a filesystem, a directory, a registry, configuration information, software product keys, a combination thereof, and the like. For example, according to an embodiment, machine backup includes an identifier of an operating system (such as Windows®, Linux®, etc.), an identifier of a database application (e.g., Apache® Derby), a filesystem, a registry file, a configuration file, a combination thereof, and the like.

Backup system 140 is configured to generate a restored database from the backup files 145. The restored database contains original data prior to backup regardless of the changes made during the backup process.

In an embodiment, backup system 140 is configured to generate a database (DB) backup based on the data stored in databases 120. In certain embodiments, DB backup includes a plurality of backup files 145. In an embodiment, the backup files 145 are a plurality of data files, stored each as a column-oriented data file. A column-oriented data file is, for example, Apache® Parquet. In an embodiment, values of each column of the database are stored in serial, contiguous, and the like, memory locations, which allows several benefits, such as improved column-wise compression and reduced query execution processing by reading only the column and not an entire row of data, where the contents of the row may not be relevant to the query.

Backup system 140 may be configured to determine a retrieval key of the database. The retrieval key may be any key, value, keyword, index, or the like. To this end, backup system 140 is configured to generate a plurality of queries based on the retrieval key, each query returning a plurality of rows of data from the database. The plurality of rows may be stored as at least a column-oriented data file, e.g., the backup files 145.

According to an embodiment, a retrieval key is a database key that includes values that are unique for each row. For example, a retrieval key is, in an embodiment, an index value. As no two rows can have the same index value, an index value can be used as a retrieval key. In some embodiments, a retrieval key is a composite key, i.e., a combination of a key value of a first column and a key value of a second column, which together form a unique value.

According to the disclosed embodiments, the backup system 140 generates metadata that facilitates the identification of relevant tables to answer an unstructured query. These tables may originate from the same database 120 or from different databases (e.g., 120-1 or 120-2), which can be of the same or different types. The metadata includes the content category of each column in every table within the database 120. In one embodiment, categorizing the content involves running a large language model (LLM) on the contents of each column to provide a description of that content. This generated description may be then used as the column name, ensuring a unified naming convention across different tables. It is important to note that while the name of a column in a table remains unchanged, it serves as a unified designation for identifying relevant tables.

For example, columns that contain residential addresses in different tables may be labeled as “home address,” “place of residency,” or “mailing address.” While the format of the content may be similar, or perhaps even identical, a language model (e.g., an LLM) would classify the contents of these columns under the same description. This information could then be processed using the LLM for classification. An example prompt may include:
“What would be a category for a column in a database having the following column values: 150 Morristown rd., Basking Ridge, NJ; 201 Broadway Ave, NY; 130 main street, Springfield NJ”

In one embodiment, the same prompt and the same large language model (LLM) are utilized to unify the column names, ensuring consistent results. An LLM can include, but is not limited to, various types of large language models, such as GPT-4 (OpenAI), Claude (Anthropic), Gemini (Google), and LLAMA (Meta), among others. In one embodiment, the generative AI system is external to system 140 and is accessed by the backup system 140 through an Application Programming Interface (API).

In an embodiment, the prompt may be a preconfigured template, where the contents of the columns are the variable parts of this template. In one example, only a subset of the values from a column is included in the prompt and provided to the language model (LLM). This approach is used to improve response time and decrease the computational resources required by the LLM.

A user device 150 allows a user to submit an input query to find information stored in a variety of tables across different databases. A user device 150 may be a laptop, a personal computer, a smartphone, or any device that can access the database backup system 140. Access is via, for example, a web portal. It should be noted that NoSQL databases do not maintain data in tables. According to the disclosed embodiments, data from NoSQL databases is stored in a table format that users can access. For example, in MongoDB, a collection of documents is used, where each document is converted into a row. Common files of the documents become columns, while any remaining files are consolidated into a final column.

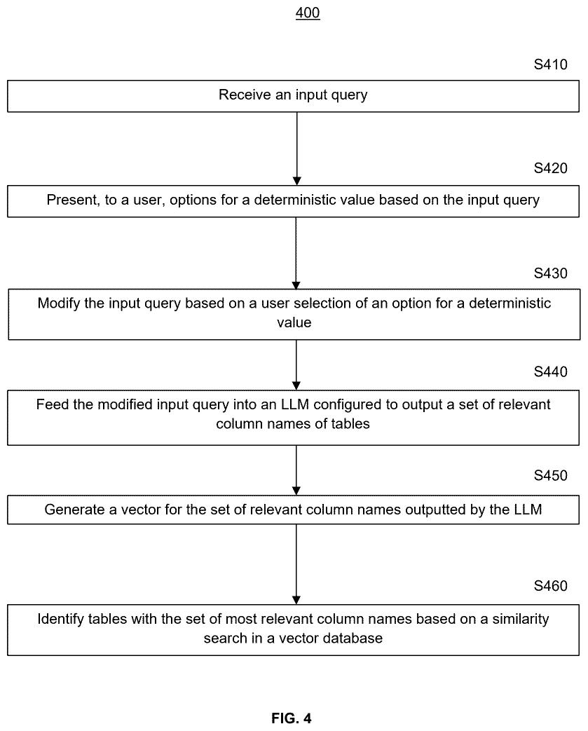

In an embodiment, the LLM used to process the generated prompt is trained or tuned based on the database tables in the DB backup. Using a trained LLM may allow for achieving accurate results in less time. In another embodiment, different versions or models may be used: one version or model may be used to unify the column names and another version or model may be used to generate sets of relevant column names (as discussed in more detail with respect to S440, FIG. 4). Each LLM may be selected to better fit the required tasks. For example, Bidirectional Encoder Representations from Transformers (BERT) can be used to unify column names, and GTP 4.0 can be used to suggest sets of relevant column names. Selection of different LLMs may be advantageous to save on computing resources and costs. However, it should be noted that the same LLM can be used for the same task.

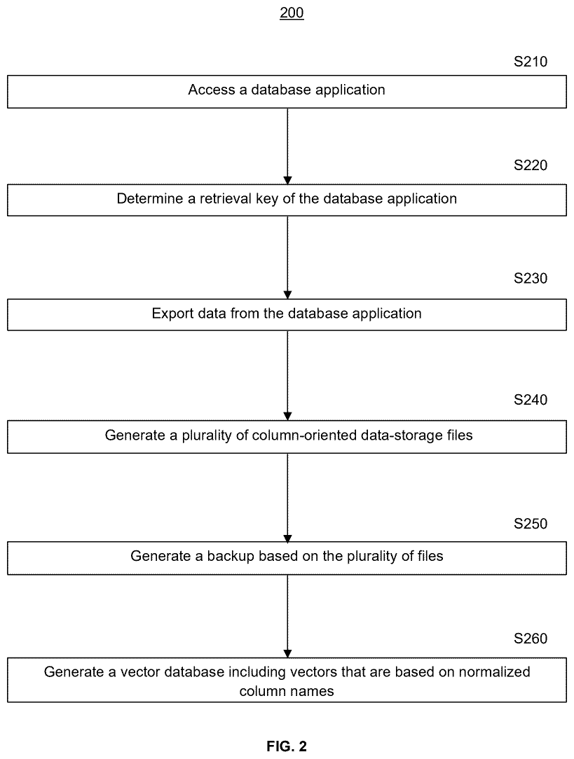

FIG. 2 is an example flowchart 200 of a method for generating a DB backup that can be utilized for finding relevant tables in accordance with an embodiment. The method may be performed by the backup system 140. In an embodiment, generating a database backup includes generating a backup of the machine hosting the database (which omits the data of the database) and generating a backup of the data of the database as two distinct backups.

At S210, a database application is accessed. In an embodiment, accessing a database application includes detecting a database application deployed in a computing environment, such as a cloud computing environment. According to some embodiments, accessing a database application includes receiving a token, a credential, a combination thereof, and the like, to access the database. In an embodiment, accessing the database application includes accessing a machine, a workload, and the like, on which the database application is deployed.

According to certain embodiments, the database application is a stand-alone database application deployed on a virtual machine. The database application may include a SQL database or a NoSQL database. Examples of NoSQL databases include MongoDB® and CouchDB®. Examples of SQL databases include PostgreSQL, MySQL, MSSQL, and the like. It should be noted that the backup process is performed for any type of database application. That is, the same process can be performed for SQL, NoSQL, or any other type of database application.

NoSQL databases use different terminology than SQL (relational) databases for the data they store. For example, in SQL databases, a “table” corresponds to a “collection,” a “row” is similar to a “document,” a “column” is equivalent to a “field,” and a “primary key” is represented by an “ID,” which serves as the default unique identifier. This description will primarily employ terminology from SQL databases for clarity, but the disclosed embodiments are not limited to these types of databases.

At S220, a retrieval key of the database is determined. In some embodiments, the retrieval key is an index of rows, for example. The retrieval key may include a value assigned to each row, which is a unique value, such that no two rows include the same value as the retrieval key.

In some embodiments, a retrieval key is generated based on a composite of multiple-column identifiers. For example, in an embodiment, two identifiers, each of a distinct column, form together a retrieval key. In certain embodiments, a plurality of retrieval keys is selected, each retrieval key corresponding to a table of the database.

At S230, data is exported from the database. The exported data may include at least tables and their contents. In an embodiment, exporting data from the database includes generating a plurality of queries. In an embodiment, the plurality of queries is generated, each based on a value range of the retrieval key. For example, in an embodiment, a first query of the plurality of queries is generated based on a value range of ‘0’ to ‘10,000’ of the retrieval key, and a second query of the plurality of queries is generated based on a value range of ‘10,001’ to ‘20,000’. In an embodiment, there is no overlap between the values of the retrieval key for each of the generated queries.

In an embodiment, the query is generated in a query language, such as SQL. In an embodiment, data is exported from the database utilizing a logical backup. For example, in a PostgreSQL database, a pg_dump command is utilized to export data from a database application to a logical backup. According to an embodiment, a logical backup includes schema and data as query language (e.g., SQL) commands, binary format, and the like. In an embodiment, a logical backup is a consistent snapshot, as opposed to a physical backup, which includes, for example, configuration files, raw files, directories, etc. As another example, in MongoDB, an export command mongoexport can be utilized to export collections (tables).

At S240, a plurality of backup files is generated. In an embodiment, the plurality of backup files is generated in a column-oriented data format, such as Apache® Parquet. In some embodiments, the plurality of backup files is generated such that a file, a group of files, etc., corresponds to a result of executing a query of the plurality of queries. Thus, data is exported from the database into a plurality of backup files.

In an embodiment, data is exported from the database application into the plurality of backup files by generating the plurality of queries, executing each query on the database, receiving a result for each query, and storing the results as data files in a column-oriented data format.

In some embodiments, for example, where a logical backup is generated (e.g., utilizing pg_dump command), the plurality of backup files is generated by converting the logical backup into a plurality of column-oriented data format files.

In some embodiments, for example, when collections are exported (e.g., utilizing mongoexport/or mongodump command), the plurality of backup files are generated by converting the logical backup into a plurality of column-oriented data format files.

At S250, a process for generating a database backup is performed. This process is executed on all exported backup files and includes unifying column names.

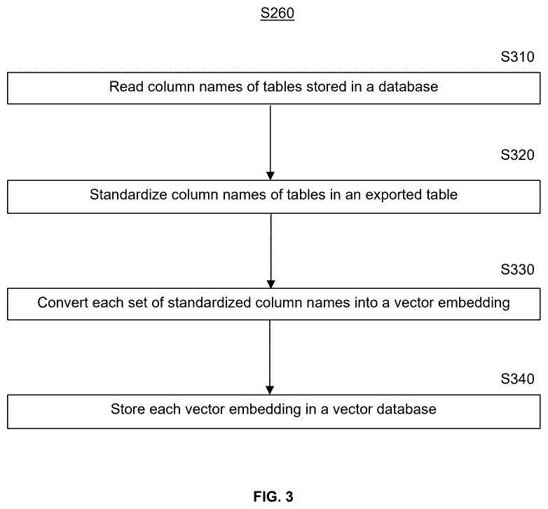

At S260, a vector database is generated. Generating a vector database includes generating embedding vectors. Each vector represents a set of standardized column names, which includes embeddings of the standardized column names as well as embeddings of the associated column contents. The generation of vectors and a vector database are discussed in further detail with respect to FIG. 3.

Reference is now made to FIG. 3, which illustrates the process of S260 for vectorizing a set of column names of tables stored in a DB backup and storing each vector in a vector database according to an embodiment. FIG. 3 may be executed by the backup system 140.

It should be noted, as mentioned above, that reference to vectorizing a set of column names includes, according to an embodiment, embedding each column name and the column contents (or portion thereof) associated with that column name.

At S310, the column names of tables stored in a database are read. In an embodiment, the tables may be stored in databases of different types, the same type, or within the same database.

At S320, the names of the columns in an exported table are standardized or unified. This process involves prompting a large language model (LLM) with the contents of each column to determine the appropriate category for that column, including a description of that content. This generated description may be used as the column name, ensuring a unified naming convention across different tables. It is important to note that while the name of a column in a table remains unchanged, it serves as a unified designation for identifying relevant tables. Metadata of each table includes the content category of each column in every table within the database 120. An example of such a prompt is provided above with respect to FIG. 1.

In an embodiment, the LLM used to unify the column names at S320 may be different than the LLM used to generate sets of relevant column names (S440, FIG. 4).

Unifying each column name, according to the above-disclosed embodiment, would ensure that similar column names would have substantially similar embedding values. This approach is used when searching for tables to improve response time and decrease the computational resources required by the backup system 140.

As a non-limiting example, table 1 may be a table of information about employees at Company X and table 2 may be a table of information about employees at Company Y. Table 1 has columns with names such as “Last Name,” “First Name,” “Social Security Number,” and “Random ID.” Table 2 has columns with names such as “Family Name,” “Given Name,” “Employee SSN,” and “Employee ID.” In this example, unifying column names may include standardizing the column names in an exported table to read: “Last Name,” “First Name,” “Social Security Number,” and “ID.” The contents in the column “Last Name,” and the contents in the column “Family Name,” are semantically similar, and “Last Name” serves as a unified column name for both of the columns. The contents in the column “Random ID” and the contents in the column “Employee ID,” are semantically similar, and “ID” serves as a unified column name for both columns. This process is illustrated in the following tables:

TABLE 1

| Last | First | | Random |
|---|---|---|---|
| Name | Name | SSN | ID |
| Smith | John | 123-45-6789 | E001 |
| Johnson | Emily | 987-65-4321 | E002 |
| Brown | Michael | 456-78-9123 | E003 |

TABLE 2

| Family | Given | Employee | Employee |
|---|---|---|---|
| Name | Name | SSN | ID |
| Davis | Sarah | 321-54-9876 | E004 |
| Wilson | Anna | 654-32-1987 | E005 |
| Martinez | David | 789-12-3456 | E006 |

Standardizing the values of column names of Table 2, according to an embodiment, would result in column names: Last Name, First Name, SNN, and Employee ID.

Additionally, the values of the contents associated with each respective column name are standardized. For example, in a column named “Weight,” there may exist entries of different weights measured in units of the imperial system e.g., 175 lbs, 120 lbs, 196 lbs, etc. In another column named “Heaviness,” there may exist entries of different weights measured in units of the metric system, e.g., 50 kg, 65 kg, 80 kg. According to this embodiment, the column name may be standardized to “Weight,” and the contents associated with the column may be standardized to be expressed in metric system units.

At S330, each set of standardized column names is converted into a vector embedding. A vector is a mathematical entity with both magnitude and direction, often represented as an array of numbers. Vectors encode information, for example, in a vector database, to allow for efficient comparison in and retrieval from a vector database.

Embedding sets of column names into vectors involves converting the sets of column names into a numerical format. This process maps the sets of column names to a point in a high-dimensional space. Each dimension in this space captures the column names in the particular set of column names as well as the contents associated with each column name in the particular set.

The content of the sets of the column names as well as the values of the contents associated with each column name influence the resulting vectors. Different sets of column names are mapped to different points in the vector space, resulting in distinct vectors. In an embodiment, a set of column names that includes the column names “Height,” “Weight,” “Date of Birth” and “Blood Pressure,” may be embedded into a vector that reflects the semantic meaning of all column names and the associated contents. This vector is embedded in a different point in the embedding space than, for example, a vector that includes column names “Company Name,” “Industry,” “Headquarters Location,” and “Revenue.”

In another embodiment, not all column names in the set of column names are embedded into a vector, but the column names that are sufficiently significant are embedded. In an embodiment, a column name is sufficiently significant based on a pre-determined threshold value. For example, in Tables 1 and 2, the column names of Random ID and Employee ID are not embedded. This approach is used to improve response time and decrease the computational resources required by the disclosed embodiments.

Additionally, in another embodiment, all contents associated with each column name are embedded and are concatenated to the respective column name embedding. For example, there may be a vector representing a set of column names that includes the column name “Weight.” Entries for weights in that column, e.g., 130 lbs, 155 lbs, 170 lbs, etc. are each embedded and concatenated to the “Weight” embedding of the vector. In some embodiments, not all entries belonging to a particular column are embedded, but only a subset of all the entries. The subset of entries is selected, according to this embodiment, to be representative of the contents of the entries in that column and serve to improve response time and decrease computational resources required to execute the disclosed embodiments.

In some embodiments, instead of embedding each set of column names into a vector, each column name (and contents associated with that particular column name) is embedded into a separate vector. Embedding individual column names (as opposed to sets of column names) as separate vectors directly in a vector database allows increased efficiency of search operations, which improves the response time and decreases the computational resources required by the disclosed embodiments. For example, in Table 1, Family Name is embedded directly to the vector DB, Given Name embedded is then directly to the vector DB, and so on.

Embedding vectors representing sets of column names, according to the disclosed embodiments, allows for performing similarity searches, for example, through cosine similarity, as it allows the backup system to compare a new vector against stored vectors and find the most similar ones. Finding the most similar vector, according to the various disclosed embodiments, means identifying the most relevant tables that contain the most relevant column names in response to an input query. Identifying the tables with the most relevant column names is discussed in further detail with respect to FIG. 4 according to an embodiment.

At S340, vector embeddings are stored in a vector database. Vector databases use clustering mechanisms and indexing mechanisms to store vectors in a way that facilitates efficient similarity searches. Clustering involves organizing the vectors so that similar ones are grouped together, making it faster to retrieve relevant results during a search. Indexes are designed to handle high-dimensional data and support various similarity search algorithms, such as cosine similarity or Euclidean distance. This setup ensures that the database can efficiently find the nearest neighbors to a given query vector.

FIG. 4 illustrates an example process 400 for identifying tables with the most relevant columns in response to an input query according to an embodiment. FIG. 4 may be executed by the backup system 140.

At S410, an input query is received. An input query is an unstructured (free text) natural language query received from a user. In an embodiment, a free text input query is a query that does not comply with any standard or proprietary query language. The input query may also include a subjective value. A subjective value is a value that may vary based on individual perspectives, opinions, or contexts. These values are not fixed and can change depending on who is interpreting them or the context in which they are used. For example, an input query may be: “find information about Moby Dick.” Moby Dick is a subjective value. Moby Dick can refer to, for example, a novel, film, or TV adaptation.

At S420, options for a deterministic value are presented to a user based on the input query. A deterministic value is a value that is specific and unambiguous. It is a fixed value that does not change regardless of context or interpretation. As a non-limiting example, options for a deterministic value in response to the input query, “find information about Moby Dick,” may be, but is not limited to, the novel, a film adaptation of the novel, or a story that inspired the novel.

In an embodiment, providing options for a deterministic value to a user allows a user to select a fixed value for the input query. This allows the input query to be modified according to the fixed value as well as the original input query.

At S430, the input query is modified based on a user selection of an option for a deterministic value. The modification of the input query based on the user selection allows the most relevant columns to be searched. For example, if a user selects an option for the film adaptation of the novel Moby Dick, a table that stores columns with names such as “Movie Title” and “Director” is more relevant than a table that stores columns with names such as “Book Title” and “Author.”

In an embodiment, steps S420 and S430 are optional. According to this embodiment, the input query to be fed into an LLM is not modified based on a selected deterministic value from a set of options given to the user. The LLM is configured to output tables that are relevant with respect to several options for the deterministic value of the input query.

At S440, the modified input query is fed into an LLM. The LLM associated with process 400 is configured to output a set of relevant column names. In an embodiment, a prompt is generated based on the modified input query. The prompt includes a pre-configured template with placeholder values. Placeholder values may include, but are not limited to, the modified input query and a task to list a set of fields (e.g., column names) in a particular type or types of databases (e.g., SQL) that are most relevant for answering the modified input query. Further, as mentioned above, the LLM utilized at S440 may be different than the LLM at S320 used to standardize the column names.

For example, a prompt for the modified input query “find information about Moby Dick film adaptations” may be: “List a set of five relevant fields in an SQL database that are the most relevant for answering the question ‘find information about Moby Dick film adaptations.’” The disclosed embodiments should not be construed as limited to the above example prompt.

In an embodiment, the LLM used to process the generated prompt is trained or tuned based on the database tables in the DB backup. Using a trained LLM may allow for achieving accurate results in less time.

At S450, a vector is generated for the set of relevant column names outputted by the LLM. For example, the set of relevant column names outputted by the LLM in response to the example prompt given at S540 may be: “Movie Name,” “Director,” “Cast,” “Plot” and “Reviews.” However, the disclosed embodiments should not be construed as limited to the above example set of relevant column names. Vectorizing the outputted set of relevant column names allows for efficiently searching a vector database for vector embeddings of sets of column names that are most similar to the vectorized outputted set of relevant column names.

At S460, tables with the set of most relevant column names are identified based on a similarity search in a vector database. In an embodiment, the similarity search is performed between the vectorized set of relevant column names outputted by the LLM and vectorized sets of relevant column names previously stored in the vector database.

For example, the vector database may store a vector that represents a set of column names that include, for example, “Book Title,” “Author,” “Publication Year,” and “Summary.” The vector, for example, is [0.1, 0.3, 0.2233, 0.1112]. The vector database may also store a vector that represents a set of column names that include, for example, “Movie Title,” “Director,” “Actors” and “Plot Summary.” The vector, for example, is [0.311, 0.093, 1.19, 0.908]. When a new set of column names (outputted by the LLM), such as “Movie Name,” “Director,” “Cast,” and “Plot,” is introduced, it is embedded into a vector, for example, as [0.31, 0.092, 1.2, 0.909]. The new vector is compared to the stored vectors using similarity measures like cosine similarity.

In this example, the database calculates the similarity between the new vector and the existing vectors stored in the vector database. According to this example, the vector [0.311, 0.093, 1.19, 0.908], corresponding to “Movie Title,” “Director,” “Actors” and “Plot Summary,” may be the closest embedding to the new vector [0.31, 0.092, 1.2, 0.909] out of all the vectors stored in the vector database, and a table corresponding to the stored vector is the most relevant table for the modified input query that corresponds to the new vector.

In some embodiments, as explained above, the vectors in the vector database that are compared to the vectors of the LLM-outputted column names are embeddings of one column name as opposed to a set of column names. According to this embodiment, each column name is embedded into a separate vector as opposed to a set of such column names being embedded into a single vector. Embedding individual column names (as opposed to sets of column names) as separate vectors directly in a vector database allows increased efficiency of the similarity search performed as disclosed, which improves the response time and decreases the computational resources required by the disclosed embodiments.

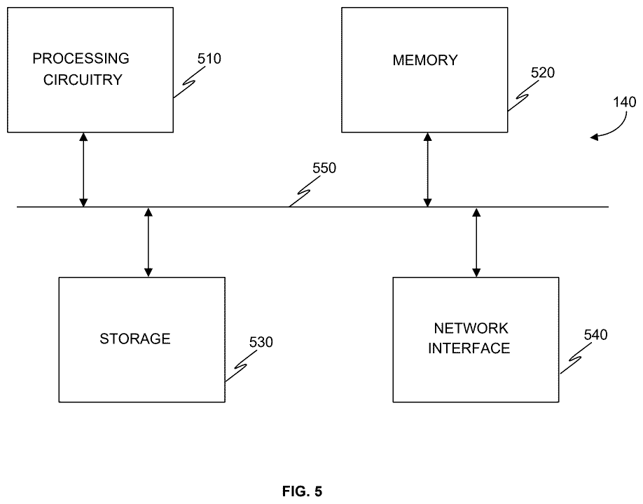

FIG. 5 is an example schematic diagram of a backup system 140 according to an embodiment. The backup system 140 includes, according to an embodiment, a processing circuitry 510 coupled to a memory 520, a storage 530, and a network interface 540. In an embodiment, the components of the backup system 140 are communicatively connected via a bus 550.

In certain embodiments, the processing circuitry 510 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information. The processing circuitry 510 is configured to operate as a generative AI system to execute, train, and/or perform inference on any type of language model. In an embodiment, the memory 520 is a volatile memory (e.g., random access memory, etc.), a non-volatile memory (e.g., read-only memory, flash memory, etc.), a combination thereof, and the like. In some embodiments, the memory 520 is an on-chip memory, an off-chip memory, a combination thereof, and the like. In certain embodiments, the memory 520 is a scratch-pad memory for the processing circuitry 510.

In one configuration, software for implementing one or more embodiments disclosed herein is stored in the storage 530, in the memory 520, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 510, cause the processing circuitry 510 to perform the various processes described herein, in accordance with an embodiment.

In some embodiments, the storage 530 is a magnetic storage, an optical storage, a solid-state storage, a combination thereof, and the like, and is realized, according to an embodiment, as a flash memory, as a hard disk drive, another memory technology, various combinations thereof, or any other medium which can be used to store the desired information.

The network interface 540 is configured to provide the backup system 140 with communication with, for example, the network 130, workload 110, database application 120, etc., according to an embodiment.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

1. A method for identifying relevant database tables in a database backup, comprising:
receiving an input query, wherein the input query is a free text query;
generating a prompt for a first language model that, when executed by a generative AI system, provides a set of column names most relevant to answering the input query;
standardizing the set of column names into the set of standardized column names, wherein each standardized column name comprises a description of contents of a column generated by a second language model based on the contents of the column, and is used to provide a unified naming convention across database tables in the database backup;
embedding a search vector for the set of standardized column names; and
identifying relevant database tables by performing a similarity search between the search vector and vectors in a vector database, wherein the vectors in the vector database represent the standardized column names and at least a portion of contents of the database tables in the database backup.

2. The method of claim 1, wherein generating a prompt for a first language model further comprises:
presenting, to a user, options for a deterministic value based on the input query, wherein a deterministic value is a value that is specific and unambiguous; and
modifying the input query based on a user selection of an option for a deterministic value, wherein the modified input query includes at least the deterministic value and the received input query.

3. The method of claim 1, wherein the database backup includes the vector database.

4. The method of claim 3, further comprising:
generating the vector database, wherein generating the vector database further comprises:
reading column names and at least a portion of contents associated with each column name of database tables in a database backup; and
standardizing the column names in an exported table.

5. The method of claim 4, further comprising:
embedding each standardized column name into a respective vector, wherein each respective vector includes embeddings of the standardized column name and at least a portion of contents associated with each standardized column name; and
storing the vector embeddings in the vector database.

6. The method of claim 4, further comprising:
embedding each standardized column name of a subset of the standardized column names selected based on a pre-determined threshold value into a respective vector, wherein each respective vector includes embeddings of the standardized column name and at least a portion of contents associated with the standardized column name; and
storing the vector embeddings in the vector database.

7. The method of claim 6, further comprising:
generating a prompt for a second language model based on at least contents of a column, wherein the prompt, when executed by the generative AI system, outputs a standardized column name of the column.

8. The method of claim 7, wherein the first language model is different than the second language model.

9. The method of claim 1, wherein the identified relevant database tables are database tables stored in the database backup, wherein the database tables are different database applications.

10. The method of claim 9, wherein a database application is at least any one of: a NoSQL database application and a SQL database application.

11. The method of claim 1, wherein the first language model is tuned based on column names in the database backup.

12. A non-transitory computer-readable medium storing a set of instructions for identifying relevant database tables in a database backup, the set of instructions comprising:
one or more instructions that, when executed by one or more processors of a device, cause the device to:
receive an input query, wherein the input query is a free text query;
generate a prompt for a first language model that, when executed by a generative AI system, provides a set of column names most relevant to answering the input query;
standardize the set of column names into the set of standardized column names, wherein each standardized column name comprises a description of contents of a column generated by a second language model based on the contents of the column, and is used to provide a unified naming convention across database tables in the database backup;
embed a search vector for the set of standardized column names; and
identify relevant database tables by performing a similarity search between the search vector and vectors in a vector database, wherein the vectors in the vector database represent the standardized column names and at least a portion of contents of the database tables in the database backup.

13. A system for identifying relevant database tables in a database backup comprising:
one or more processors configured to:
receive an input query, wherein the input query is a free text query;
generate a prompt for a first language model that, when executed by a generative AI system, provides a set of column names most relevant to answering the input query;
standardize the set of column names into the set of standardized column names, wherein each standardized column name comprises a description of contents of a column generated by a second language model based on the contents of the column, and is used to provide a unified naming convention across database tables in the database backup;
embed a search vector for the set of standardized column names; and
identify relevant database tables by performing a similarity search between the search vector and vectors in a vector database, wherein the vectors in the vector database represent the standardized column names and at least a portion of contents of the database tables in the database backup.

14. The system of claim 13, wherein the one or more processors, when generating a prompt for a first language model, are configured to:
present, to a user, options for a deterministic value based on the input query, wherein a deterministic value is a value that is specific and unambiguous; and
modify the input query based on a user selection of an option for a deterministic value, wherein the modified input query includes at least the deterministic value and the received input query.

15. The system of claim 13, wherein the database backup includes the vector database.

16. The system of claim 15, wherein the one or more processors are further configured to:
generate the vector database, wherein generating the vector database further comprises:
read column names and at least a portion of contents associated with each column name of database tables in a database backup; and
standardize the column names in an exported table.

17. The system of claim 16, wherein the one or more processors are further configured to:
embed each standardized column name into a respective vector, wherein each respective vector includes embeddings of the standardized column name and at least a portion of contents associated with each standardized column name; and
store the vector embeddings in the vector database.

18. The system of claim 16, wherein the one or more processors are further configured to:
embed each standardized column name of a subset of the standardized column names selected based on a pre-determined threshold value into a respective vector, wherein each respective vector includes embeddings of the standardized column name and at least a portion of contents associated with the standardized column name; and
store the vector embeddings in the vector database.

19. The system of claim 18, wherein the one or more processors are further configured to:
generate a prompt for a second language model based on at least contents of a column, wherein the prompt, when executed by the generative AI system, outputs a standardized column name of the column.

20. The system of claim 19, wherein the first language model is different than the second language model.

21. The system of claim 13, wherein the identified relevant database tables are database tables stored in the database backup, the database tables are different database applications.

22. The system of claim 21, wherein a database application is at least any one of:
a NoSQL database application and a SQL database application.

23. The system of claim 13, wherein the first language model is tuned based on column names in the database backup.
